(19) United States
(12) Patent Application Publication
(10) Pub. No.: US 2025/0155737 A1
(43) Pub. Date: May 15, 2025

(54) DIFFERENTIAL DRIVE AND BINARY WEIGHTED MODULATORS

(71) Applicant: HyperLight Corporation, Cambridge, MA (US)

(72) Inventors: Christian Reimer, Wellesley, MA (US); Christopher Cole, Redwood City, CA (US); Jeffrey Cole Holzgrafe, Somerville, MA (US)

(21) Appl. No.: 18/946,784

(22) Filed: Nov. 13, 2024

Related U.S. Application Data
(60) Provisional application No. 63/548,510, filed on Nov. 14, 2023.

(51) Int. Cl. G02F 1/035; G02F 1/01

(52) U.S. Cl. CPC G02F 1/035; G02F 1/0121

(57) ABSTRACT

An optical modulator including a driving module, waveguide(s), and differential electrodes is described. The driving module has a first number of differential inputs and a second number of differential outputs. The second number is equal to the first number multiplied by an even integer. The waveguide(s) include a thin film lithium-containing (TFLC) electro-optic material. Each of the waveguide(s) has multiple arms. The differential electrodes are coupled to the second number of differential outputs, each of the plurality of differential electrodes including a positive electrode and a negative electrode, at least a portion of an arm of the plurality of arms between a portion of the positive electrode and a portion of the negative electrode.

### CROSS REFERENCE TO OTHER APPLICATIONS

This application claims priority to U.S. Provisional Patent Application No. 63/548,510 entitled DIFFERENTIAL DRIVE AND BINARY WEIGHTED MODULATORS filed Nov. 14, 2023 which is incorporated herein by reference for all purposes.

### BACKGROUND OF THE INVENTION

An optical modulator typically includes one or more waveguides formed using materials having an index of refraction that is sensitive to electric fields. The waveguide(s) carry an optical signal. The modulator also includes electrodes that apply an electric field to the waveguide to alter the index of refraction of the waveguide. As a result, the phase, intensity and/or polarization of the optical signal traversing the waveguide can be modulated.

Optical modulators and other electro-optic devices are also desired to meet certain performance benchmarks and are configured for particular applications. For example, an optical modulator is desired to be capable of providing sufficient optical modulation at lower electrode driving voltages. The optical modulator is also desired to have low electrode (e.g. microwave) signal losses for the electrical signal through the electrodes and low optical losses for the optical signal traversing the waveguide. Further, the optical modulators are desired to be capable of providing low loss transmission and large modulation at low voltages over a wide bandwidth of frequencies. Therefore, an electro-optic device that may have low electrode losses, low optical losses, operate at high frequencies, and/or provide the desired optical modulation at low driver voltages is desired.

### BRIEF DESCRIPTION OF THE DRAWINGS

Various embodiments of the invention are disclosed in the following detailed description and the accompanying drawings.

FIGS. 1A-1C depict an embodiment of an electro-optic device.

FIG. 2 depicts an embodiment of an electro-optic device.

FIG. 3 depicts an embodiment of a linear driver usable in an electro-optic device.

FIG. 4 depicts an embodiment of an electro-optic device.

FIGS. 5A-5C depict embodiments of electro-optic devices.

FIG. 6 depicts an embodiment of a driver usable for an electro-optic device.

FIG. 7 depicts an embodiment of an electro-optic device.

FIG. 8 depicts an embodiment of an electro-optic device.

FIGS. 9A-9C depict embodiments of electro-optic devices.

FIGS. 10A-10D depict embodiments of electro-optic devices.

FIG. 11 is a flow-chart depicting an embodiment of a method for modulating an optical signal.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

An electro-optic device (also termed an optic device), such as an electro-optical modulator (also termed an optical modulator) typically includes one or more waveguides that carry optical signal(s) and electrodes that carry electrical signals. The waveguide(s) are formed using material(s) having an index of refraction that is sensitive to electric fields. The electrodes apply an electric field to the waveguide to alter the index of refraction of the waveguide. To apply this electric field, a signal is input to the electrodes. This signal is a time-varying electrical signal, typically having frequencies in the microwave range. More specifically, a driver receives a data signal and provides a corresponding electrical signal to the electrodes. Typically, the driver is external to the optical modulator. For example, the driver is typically off-chip, while the waveguide(s) and electrodes are on-chip. In regions in which the electrodes are in proximity to the waveguide, an electric field due to the signal traveling through the electrodes modulates the index of refraction of the waveguide. As a result, the phase, intensity and/or polarization of the optical signal traversing the waveguide can be modulated.

Although electro-optic devices function, their performance may be limited by a number of factors. For example, electrodes may suffer from electrode (e.g. microwave) signal losses as the microwave signal traverses the electrode. Such losses may be increased by proximity to the waveguide. These losses may adversely affect the ability of the electrode to provide the desired electric field at the waveguide. Absorption of the microwave signal by surrounding structures as well as resistive losses in the electrode exacerbate these losses. Furthermore, the requisite driving voltage for the electrodes increases with increasing frequency of the modulation. For example, an optical signal may be readily modulated at a frequency of 1 GHz using an electrode voltage of less than two volts. However, for higher frequencies, for example in the 100 GHz range or higher, the requisite electrode voltage may be significantly higher (e.g. five volts or more). A larger voltage is applied to the electrodes in order to obtain the desired change in index of refraction. Thus, optical modulators may require larger input voltages to the electrodes and consume more power than is desirable. Drivers may require a higher voltage than is desirable. Consequently, electro-optic devices having improved performance are still desired.

Many technologies have been proposed to improve optical modulators. These technologies include waveguides utilizing semiconductors (e.g. silicon and/or indium phosphide), bulk lithium niobate (LN), barium titanate (BTO), and/or plasmonics. However, these and other technologies suffer significant drawbacks in one or more of the characteristics mentioned above. A single limiting factor in performance of an optical modulator may also prevent the optical modulator from functioning as desired. For example, unacceptable electrode (microwave) losses or a high driving voltage may render the modulator unusable for particular applications. Consequently, mechanisms for providing, connecting to and utilizing an optical device having low optical signal losses, low electrode signal losses, and/or providing the desired optical modulation at lower voltages are still desired.

An optical modulator including a driving module, waveguide(s), and differential electrodes is described. The driving module has a first number of differential inputs and a second number of differential outputs. The second number is equal to the first number multiplied by an even integer. The waveguide(s) include a thin film lithium-containing (TFLC) electro-optic material. Each of the waveguide(s) has multiple arms. The differential electrodes are coupled to the second number of differential outputs, each of the plurality of differential electrodes including a positive electrode and a negative electrode, at least a portion of an arm of the plurality of arms between a portion of the positive electrode and a portion of the negative electrode.

In some embodiments, the optical modulator also includes a digital signal processor (DSP) having at least one input and a plurality of differential outputs. The differential outputs of the DSP are coupled with the first number of differential inputs for the driving module. The driving module includes a linear driver coupled with the DSP. The linear driver is configured to convert the first number of differential inputs to the second number of differential outputs. In some embodiments, the DSP further provides a dither tone. The differential electrodes provide feedback to the DSP based on the dither tone. The DSP is configured to trim signals provided on the differential outputs based on the feedback.

In some embodiments, the driving module includes a digital signal processor (DSP) and a driver. The DSP has at least one input and differential outputs. The differential outputs of the DSP are coupled with the first number of differential inputs for the driving module, The driver is coupled with the DSP and configured to convert the first number of differential inputs to the second number of differential outputs.

The driving module provides differential signals on the differential outputs. The differential signals having a zero DC component. In some embodiments, a first signal is provided to the positive electrode and a second signal is provided to the negative electrode of a differential electrode of the plurality of differential electrodes. The first signal is different from the second signal. Each of the first signal and the second signal includes at least one of a binary signal, a PAM-4 signal, a PAM 8 signal, a PAM-16 signal, a PAM-32 signal, and a PAM 64 signal.

In some embodiments, the portion of the positive electrode is proximate to the arm along a first distance. The portion of the negative electrode is proximate to the arm for a second distance for an of the plurality of arms. The first distance is different from the second distance. The optical driving module includes an open collector. The positive electrode and the negative electrode of each differential electrodes are terminated through at least one resistor to a voltage load. In some embodiments, ground lines are interleaved with the differential electrodes. In some embodiments, the ground lines are biased at a common voltage.

In some embodiments, the waveguide(s), the driver module, and the differential outputs are configured to function as an intensity modulator, an intensity modulation direct detection (IMDD) modulator, and an in-phase quadrature (IQ) modulator. The optical modulator may have a bandwidth including a frequency of one hundred GHz and not more than three hundred GHz. In some embodiments, the bandwidth has a minimum frequency of not less than 50 GHz.

An optical modulator including a driving module, waveguides and differential electrodes is described. The driving module includes a digital signal processor (DSP) and a linear driver coupled with the DSP. The DSP has input(s) and differential outputs. The linear driver has a first number of differential inputs and a second number of differential outputs. The differential outputs of the DSP are coupled with the first number of differential inputs for the linear driver. The linear driver is configured to convert the first number of differential inputs to a second number of differential outputs. The second number is the first number multiplied by an even integer. The linear driver has a loss of not more than 3 dB. The waveguides include a thin film lithium-containing (TFLC) electro-optic material. Each of the waveguides has a plurality of arms. The differential electrodes are coupled to the second number of differential outputs. Each of the differential electrodes includes a positive electrode and a negative electrode. At least a portion of an arm of the plurality of arms is between a portion of the positive electrode and a portion of the negative electrode. The optical modulator has a bandwidth including a frequency of one hundred GHz. The bandwidth does not exceed a maximum frequency of three hundred GHz. In some embodiments, the driving module provides differential signals on the differential outputs. The differential signals have a zero DC component. In some embodiments, a first signal is provided to the positive electrode and a second signal is provided to the negative electrode of a differential electrode. The first signal is different from the second signal.

A method is described. The method includes providing, from a driving module having a first number of differential inputs and a second number of differential outputs and to a plurality of differential electrodes, a plurality of differential signals. The second number is equal to the first number multiplied by an even integer. The method also includes providing, to each of a plurality of waveguides including a thin film lithium-containing (TFLC) electro-optic material, an optical signal. Each of the waveguides has a plurality of arms. Each of the differential electrodes includes a positive electrode and a negative electrode. At least a portion of an arm of the plurality of arms is between a portion of the positive electrode and a portion of the negative electrode. The differential signals modulate the optical signal in each of the waveguides. The method also includes combining the modulated optical signal from each of the waveguides. In some embodiments, providing the differential signals includes providing a first signal to the positive electrode and a second signal to the negative electrode of a differential electrode. The first signal is different from the second signal. Each of the first signal and the second signal may include at least one of a binary signal, a PAM-4 signal, a PAM 8 signal, a PAM-16 signal, a PAM-32 signal, and a PAM 64 signal. In some embodiments, the waveguides, the driver module, and the differential outputs are configured to function as an intensity modulator, an intensity modulation direct detection (IMDD) modulator, and an in-phase quadrature (IQ) modulator.

The techniques are also described in the context of positive and negative electrodes, positive and negative voltages, positive and negative inputs, and positive and negative outputs. However, such electrodes, voltages, inputs, and outputs carry or are signals that are opposite in polarity with respect to a reference. Stated differently, positive and negative refer to polarity with respect to a reference. In some embodiments, the reference is ground. In some embodiments, the reference is a nonzero voltage. In such embodiments, the positive voltage line has the opposite polarity with respect to the nonzero voltage as the negative voltage. Thus, the terms “positive” and “negative” simply indicate that the signals are opposite in polarity with respect to the reference. There is no requirement that the “positive” signal remain positive with respect to the reference or that the “negative” signal remains negative with respect to the reference. In addition, various features of the electro-optic devices are described herein. One or more of these features may be combined in manners not explicitly described herein.

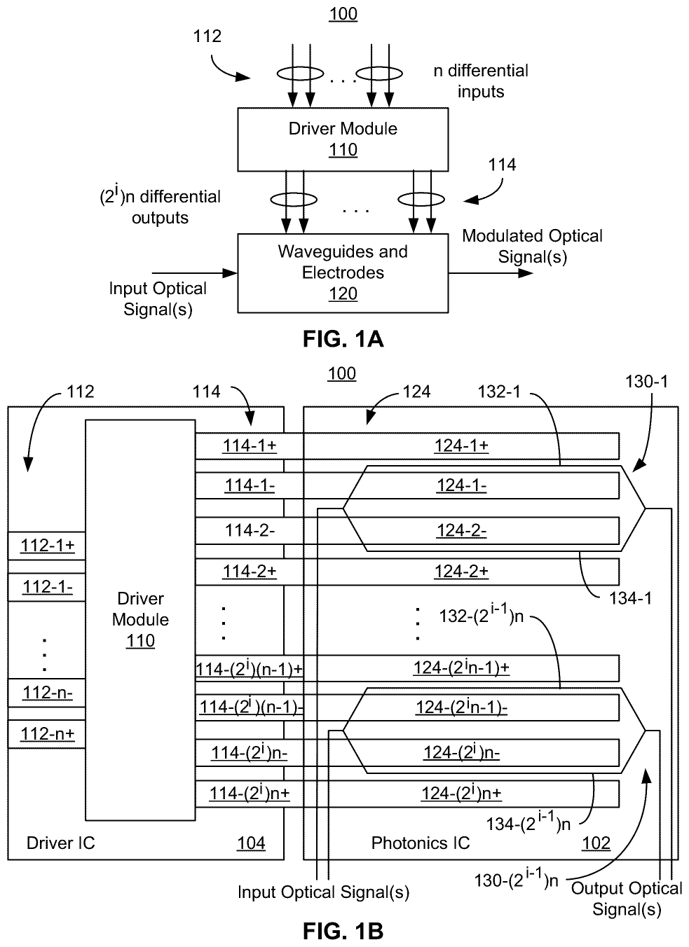

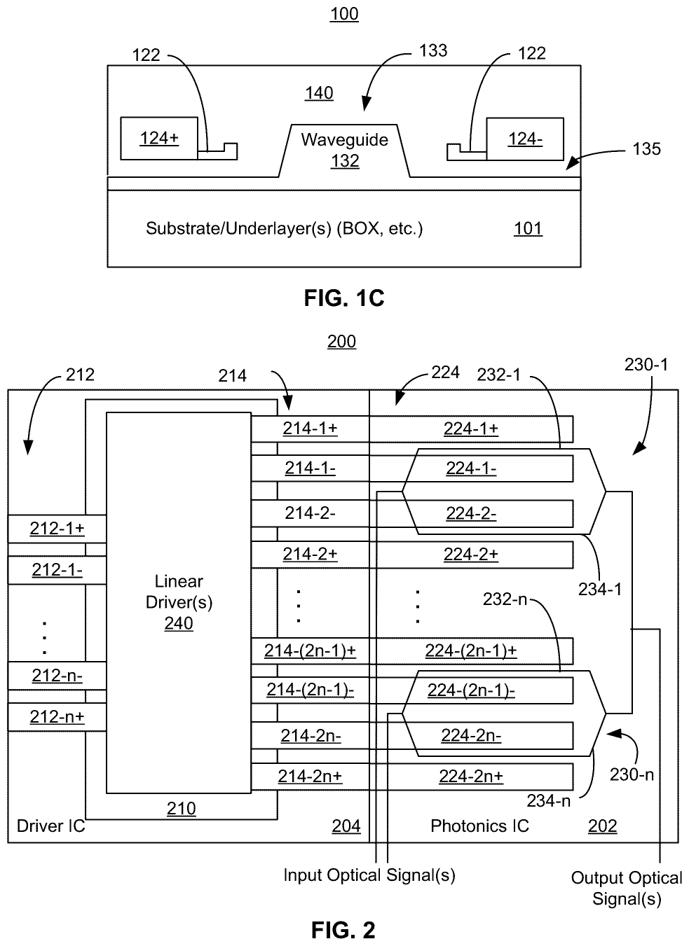

FIGS. 1A-1C depict an embodiment of electro-optic device 100. FIGS. 1A, 1B, and 1C depict a block diagram, a plan view, and a cross-sectional view of a portion of electro-optic device 100. For clarity, not all components are shown and FIGS. 1A-1C are not to scale. Referring to FIG. 1A, electro-optic device 100 includes driver module 110 and photonics 120 (including, e.g., waveguides and electrodes). Driver module includes 110 differential inputs 112 and differential outputs 114. Driver module 110 is configured such that the number of differential outputs 114 is an even integer (i.e. a multiple of two) multiplied by the number of differential inputs 112. For example, for n differential inputs 112, driver module has (2ⁱ) n differential outputs 114, where i is an integer. In some embodiments, driver module 110 includes an amplifier that splits the input signal(s) (e.g. received from a conventional or custom digital signal processor, or DSP) and amplifies the differential signals. Such an amplifier may be a linear amplifier. In some embodiments, driver module 110 may include both a DSP and an amplifier. In such embodiments, driver module 110 may include custom components.

FIG. 1B depicts a plan view of electro-optic device 100, including a driver integrated circuit 104 and photonics integrated circuit 102. In some embodiments, integrated circuits 102 and 104 may be packaged together. For example, driver integrated circuit 104 may be mounted on photonics integrated circuit 102, or vice versa. Driver integrated circuit 104 includes driver module 110, differential inputs 112, and differential outputs 114. Individual differential inputs 112 and differential outputs 114 are shown. Electro-optic device 100 thus includes positive differential inputs 112-j+ and negative differential inputs 112-j−, where j is an integer from 1 through n. Similarly, driver integrated circuit 104 includes positive differential outputs 114-j+ and negative differential outputs 114-j−, where j is an integer from 1 through (2ⁱ)n. Differential inputs 112 and differential outputs 114 carry differential signals (e.g. microwave signals).

Photonics integrated circuit 102 includes waveguides 130-j (collectively or generically 130), where j is an integer from 1 through (2ⁱ⁻¹)n. Each waveguide 130-j includes two arms 132-j and 134-j (collectively or generically 132 and 134), where j is an integer from 1 through (2ⁱ⁻¹)n. Each waveguide arm 132 and 134 has differential electrodes 124 proximate to at least a portion of the arm 132 and 124. Thus, differential electrodes 124 include positive differential electrodes 124-j+ and negative differential electrodes 124-j−, where j is an integer from 1 through (2ⁱ)n. Stated differently, the optical signal in each arm 132 and 134 is modulated by a differential signal accrued in electrodes 124-j+ and 124-j=. Although not shown in FIG. 1B, ground lines may reside between electrodes for each arm 132 or 134 (e.g., above electro 124-1+, between electrodes 124-1− and 124-2−, and/or between electrode 124-2+ and 124-3+ (not explicitly shown in FIG. 1B)).

FIG. 1C depicts a cross-sectional view of one arm 132 of waveguide 130 of electro-optic device 100. Waveguide 130 includes ridge 133 portion and slab portion 135. In some embodiments, slab portion 135 may be omitted. The optical mode carried by waveguide 130 is generally well confined to ridge portion 133. Also shown are differential electrodes 124 (positive electrode 124+ and negative electrode 124−). In some embodiments, extensions 122 may extend from differential electrodes 124. Such extensions may allow for accumulation of charges closer to arm 132 (e.g., ridge 133) of waveguide 130. These charges are due to the electrode signals carried by differential electrodes 124. Thus, the electric field experienced by ridge 133 may be enhanced and modulation of the optical signal carried by arm 132 improved. Embodiments of analogous electrodes may be found in co-pending U.S. patent application Ser. No. 17/843,906, entitled ELECTRO-OPTIC DEVICES HAVING ENGINEERED ELECTRODES, which is a continuation of U.S. patent application Ser. No. 17/102,047 entitled ELECTRO-OPTIC DEVICES HAVING ENGINEERED ELECTRODES, filed Nov. 23, 2020, which claims priority to U.S. Provisional Patent Application No. 62/941,139 entitled THIN-FILM ELECTRO-OPTIC MODULATORS filed Nov. 27, 2019, U.S. Provisional Patent Application No. 63/033,666 entitled HIGH PERFORMANCE OPTICAL MODULATORS filed Jun. 2, 2020, and U.S. Provisional Patent Application No. 63/112,867 entitled BREAKING VOLTAGE-BANDWIDTH LIMIT IN INTEGRATED LITHIUM NIOBATE MODULATORS USING MICRO-STRUCTURED ELECTRODES filed Nov. 12, 2020, all of which are incorporated herein by reference for all purposes. Also shown is substrate structure 101. In some embodiments, substrate structure 101 includes an underlying substrate (e.g., silicon) and a thick buried oxide layer between slab 135 and the underlying substrate. Other components may be present in substrate structure 101 but are not shown for simplicity.

Referring to FIGS. 1A-1C, waveguides 130 (and thus each arm 132 and 134) each includes at least one optical material possessing an electro-optic effect. In some embodiments, waveguides 130 include thin film lithium containing (TFLC) electro-optic materials, such as thin film lithium niobate (TFLN) and/or thin film lithium tantalate (TFLT). In some embodiments, waveguides 130 consist of TFLN and/or TFLT. For example, the thickness of the electro-optic layer form which waveguides 130 are formed is not more than three micrometers prior to fabrication of waveguides 130. In some embodiments, this thickness is not more than 1.5 micrometer or not more than one micrometer. In some embodiments, the thickness is not more than seven hundred nanometers or not more than five hundred nanometers. In some embodiments, the thickness is at least one hundred nanometers. Other thicknesses are possible. The thickness of waveguides 130 is less than or equal to the thickness of the as-provided electro-optic layer. For example, the thickness of waveguides 130 may be on the order of a few hundred nanometers or less.

Although primarily described in the context of (TFLC) electro-optic materials, such as thin film lithium niobate (TFLN) and thin film lithium tantalate (TFLT), other nonlinear optical materials may be used in the optical devices described herein. For example, other ferroelectric nonlinear (e.g. second order) optical materials may also be desired to be used in waveguides 130. Such ferroelectric nonlinear optical materials may include but are not limited to potassium niobate (e.g. KNbO₃), gallium arsenide (GaAs), potassium titanyl phosphate (KTP), lead zirconate titanate (PZT), and barium titanate (BaTiO₃). The techniques described may also be used for other nonlinear ferroelectric optical materials, particularly those which may otherwise be challenging to fabricate. For example, such nonlinear ferroelectric optical materials may have inert chemical etching reactions using conventional etching chemicals such as fluorine, chlorine or bromine compounds.

In some embodiments, the optical material(s) used in waveguide(s) 130 are nonlinear. As used herein, a nonlinear optical material exhibits the electro-optic effect and has an effect that is at least (e.g. greater than or equal to) 5 picometer/volt. In some embodiments, the nonlinear optical material has an effect that is at least 10 picometer/volt. In some such embodiments nonlinear optical material has an effect of at least 20 picometer/volt. The nonlinear optical material experiences a change in index of refraction in response to an applied electric field. In some embodiments, the nonlinear optical material is ferroelectric. In some embodiments, the electro-optic material effect includes a change in index of refraction in an applied electric field due to the Pockels effect. Thus, in some embodiments, optical materials possessing the electro-optic effect in one or more the ranges described herein are considered nonlinear optical materials regardless of whether the effect is linearly or nonlinearly dependent on the applied electric field. The nonlinear optical material may be a non-centrosymmetric material. Therefore, the nonlinear optical material may be piezoelectric. Such nonlinear optical materials may have inert chemical etching reactions for conventional etching using chemicals such as fluorine, chlorine or bromine compounds. In some embodiments, the nonlinear optical material(s) include one or more of LN, LT, potassium niobate, gallium arsenide, potassium titanyl phosphate, lead zirconate titanate, and barium titanate. In other embodiments, other nonlinear optical materials having analogous optical characteristics may be used.

In some embodiments, waveguides 130 are low optical loss waveguides. For example, waveguides 130 may each have a total optical loss of not more than 10 dB through the portion of waveguide 130 (e.g. when biased at maximum transmission and as a maximum loss) in proximity to differential electrodes 124. The total optical loss is the optical loss in a waveguide through a single continuous electrode region (e.g. as opposed to multiple devices cascaded together). In some embodiments, waveguides 130 has a total optical loss of not more than 8 dB. In some embodiments, the total optical loss is not more than 4 dB. In some embodiments, the total optical loss is less than 3 dB. In some embodiments, the total optical loss is less than 2 dB. In some embodiments, waveguides 130 has an optical loss of not more than 3 dB/cm (e.g. on average). In some embodiments, the nonlinear material(s) in waveguides 130 has an optical loss of not more than 2.0 dB/cm. In some such embodiments, waveguide 130 has an optical loss of not more than 1.0 dB/cm. In some embodiments, waveguide 130 has an optical loss of not more than 0.5 dB/cm. In some embodiments, the low optical losses are associated with a low surface roughness of the side walls of waveguides 130.

Waveguide 130 may have improved surface roughness. For example, the short range root mean square surface roughness of a sidewall of the ridge 133 may be less than ten nanometers. In some embodiments, this root mean square surface roughness is not more than five nanometers. In some cases, the short range root mean square surface roughness does not exceed two nanometers. In some embodiments, the height of ridge 133 is selected to provide a confinement of the optical mode such that there is a 10 dB reduction in intensity from the intensity at the center of ridge 133 at ten micrometers from the center of ridge 133. For example, the height of ridge 133 is on the order of a few hundred nanometers in some cases. However, other heights are possible in other embodiments.

Various other optical components may be incorporated into waveguides 130 to provide the desired phase modulation, polarization modulation, intensity modulation, in phase quadrature (IQ) modulation, dual polarization IQ (DPIQ) modulation, other modulation and/or other functionality. For example, waveguide 130 may have wider portion(s) (not shown in FIGS. 1A-1C) for accommodating multiple modes. In some embodiments (not shown in FIGS. 1A-1C), waveguides 130 may include additional splitters to divide the optical signal into multiple branches for modulation and recombine the modulated optical signals for output. Thus, waveguides 130, as well as differential electrodes 124, may be configured to provide the desired functionality.

In operation, optical signal(s) are provided to waveguides 130. Although each waveguide 130 is shown has having a separate input optical signal, in some embodiments, a particular input optical signal may be split and provided to multiple waveguides 130. Each waveguide 130 splits the optical signals into arms 132 and 134. In some embodiments, optical signals are evenly split between arms 132 and 134 (e.g. half of the intensity to each arm 132 and 134). In other embodiments, the optical signals may be split differently. Differential signals are provided to inputs 112 (e.g. from a DSP that is not shown). Driver module 110 splits the differential signals, amplifies the signals and provides the signals to differential electrodes 124 via differential outputs 114. The differential electrode signals carried by differential electrodes 124 modulate the optical signal in the arms 132 and 134 in regions where differential electrodes are proximate to arms 132 and 134 of waveguide 130. For example, the location of portions of waveguides 130 may be further from electrodes 124 than appears in the plan view of FIG. 1B. For example, portions of waveguide 130 may be separated by a distance out of the plane of the page for FIG. 1B (e.g., portions of waveguide 130 may be buried deeper in the device 100 or portions of differential electrodes 124 may be further from substrate structure 101). The modulated optical signal for each arm 132 and 134 of a waveguide 130 are recombined. In the embodiment shown, the combined, modulated optical signal for each waveguide 130 is output. In other embodiments, the combined, modulated optical signal for each waveguide 130 are combined and then output.

Thus, electro-optic device 100 may provide improved performance. For example, because differential signals are used to modulate the optical signal on each arm 132 and 134, a lower voltage may be used to drive electro-optic device 100 to provide the desired Vx. In some embodiments, the swing voltage (the difference between the maximum positive electrode signal and minimum negative electrode signal) may be half of that for a non-differential modulator. Thus, power savings and the ability to drive electro-optic device 100 using circuitry, such as CMOS circuitry, may be achieved. Further, driving module 110 may be configured such that the differential signals swing around zero (e.g. the common mode is zero), which may be desirable. For example, a zero DC signal may be generated by the DSP used with driving module 110 (or driving module 110) may generate the zero DC. In some embodiments, the non-zero DC signal may be generated, and another component used to remove the DC component. The component removing the DC component may be an active element such as an RF driver that also amplifies or spectrally shapes the electrical signal. In some embodiments, the element removing the DC component may include passive device(s) acting as a high-pass filter, only transmitting electrical signals with frequency components larger than a chosen DC cut-off. Other embodiments are possible.

Because waveguides 130 are formed from electro-optic material(s) such as TFLC optical materials, waveguides 130 may be low loss, low jitter, and high bandwidth. In some embodiments, differential signals having frequency bandwidths including 100 GHz and/or 200 GHz may be used. For example, electro-optic device 100 may have a bandwidth from a minimum frequency of DC (or 100 MHz, 10GHz, or 50 GHz) through 100 GHz or 200 GHz (e.g. to a maximum frequency of 200 GHz, 300 GHz, or greater). Thus, in some embodiments, electro-optic device 100 operates as desired for frequencies of at least 100 GHz or at least 200 GHz. Consequently, performance of electro-optic device 100 may be improved.

In addition, various electrodes signals may be utilized. In some embodiments, the electrode signals carried by positive electrode 124-j+ and negative electrode 124-j− are complementary, or oppositely polarized (e.g. simply one hundred and eighty degrees out of phase). In such embodiments, the same data is carried by each electrode 124-j+and 124-j−. This allows for a reduction in the driving voltage used to modulate the optical signal. In some embodiments, binary weighting may be used to combine signals in electro-optic device 100. For example, the electrode signals carried by electrodes 124-j+ and 124-j− may include at least one of a binary signal, a PAM-4 signal, a PAM 8 signal, a PAM-16 signal, a PAM-32 signal, and a PAM 64 signal. Signals to different electrodes 124 may also be weighted differently (e.g. amplified differently). In one example, two complementary signals may be biased to have different voltage amplitudes and combined. In one example, two different non-return-to-zero (NRZ) signals having a tailored voltage amplitude may be combined by waveguides 130 to provide a 2-bit PAM-4 signal from device 100. In some cases, one differential signal may be weighted (e.g. amplified) more than the other signal. In another example, one 1-bit NRZ signal (e.g., on electrode 124-j+) and one 2-bit PAM-4 signal (e.g., on electrode 124-j−) are combined to provide a 3-bit PAM-8 signal. Similarly, two 2-bit PAM-4 signals (e.g., one on each electrode 124-j+and 124-j-) are combined to provide a 4-bit PAM-16 signal. Other combinations of signals are possible. In such embodiments, the complexity of driving module 110 (or the DSP providing signals to driving module 110) may be simplified. For example, fewer levels of the signal may be implemented electronically. Instead, operation of waveguides 130 may be used to combine the signals. Further, less power may be used by driver integrated circuit 104. Thus, performance may be improved.

FIG. 2 depicts a plan view of an embodiment of electro-optic device 200. For clarity, not all components are shown and FIG. 2 is not to scale. Electro-optic device 200 includes driver integrated circuit 204, driver module 210, differential inputs 212, differential outputs 214, photonics integrated circuit 202, waveguides 230, and differential electrodes 224 that are analogous to driver integrated circuit 104, driver module 110, differential inputs 112, differential outputs 114, photonics integrated circuit 102, waveguides 130, and differential electrodes 124 of electro-optic device 100. In the embodiment shown in FIG. 2, the output optical signals from waveguides 230 are combined. In other embodiments, the output optical signals may not be combined or may be combined in a different manner. Further, as can be seen in FIG. 2, the number of differential outputs 214 and thus the number of differential electrodes 224 is an even integer multiplied by the number of differential inputs 212.

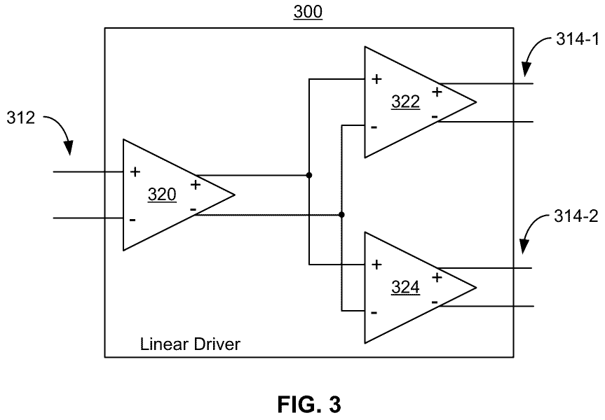

In addition, driver module 210 includes linear driver(s) 240. Linear driver 240 splits and amplifies the differential signals from differential inputs 212 and provides the amplified differential signals to differential outputs 214. Linear driver 240 receives input differential signals via differential inputs 212. In some embodiments, the differential signals are provided form a DSP (not shown in FIG. 2). In some embodiments, such a DSP may be a standard DSP. In the embodiment shown, driver 240 may be a linear driver. For example, FIG. 3 depicts an embodiment of linear driver 300 usable in an electro-optic device, such as electro-optic device 200 (and/or 100). Linear driver 300 includes amplifier 320, 322, and 320 that receive a differential signal on inputs 312, amplify and split the differential signal, and output two sets of differential signals on outputs 314-1 and 314-2. In some embodiments, linear driver 300 may be configured to provide complementary differential signals on output 314-1 or 314-2. Thus, the modulation is additive for the optical signal and a lower voltage may be used for achieving the desired Vπ. In some embodiments, linear driver 300 is configured to have no common-mode DC signal (e.g. the voltage swing is around zero volts). In some embodiments, multiple copies of linear driver 300 may be used within linear driver(s) 240. For example, at least one linear driver 300 may be used for each differential inputs 212-j.

Electro-optic device 200 operates in an analogous manner to and may share the benefits of electro-optic device 100. For example, electro-optic device 200 may be low jitter, have a high bandwidth, low loss, use a lower driving voltage for the desired Vπ, and a zero common mode. Moreover, binary weighted signals may be combined (e.g. two NRZ combined to form a PAM-4 signal). Thus, the DSP (not shown) may be simplified and less power used in driving electro-optic device 200. Thus, performance may be improved. Further, traces that are shorter than the wavelength of the RF signal may be used in linear amplifier 300. Such short traces (e.g., connecting amplifiers 320 and 322) allows these components to act as nodes, rather than transmission lines. Consequently, losses may be reduced. Performance of electro-optic device 200 may, therefore, be improved.

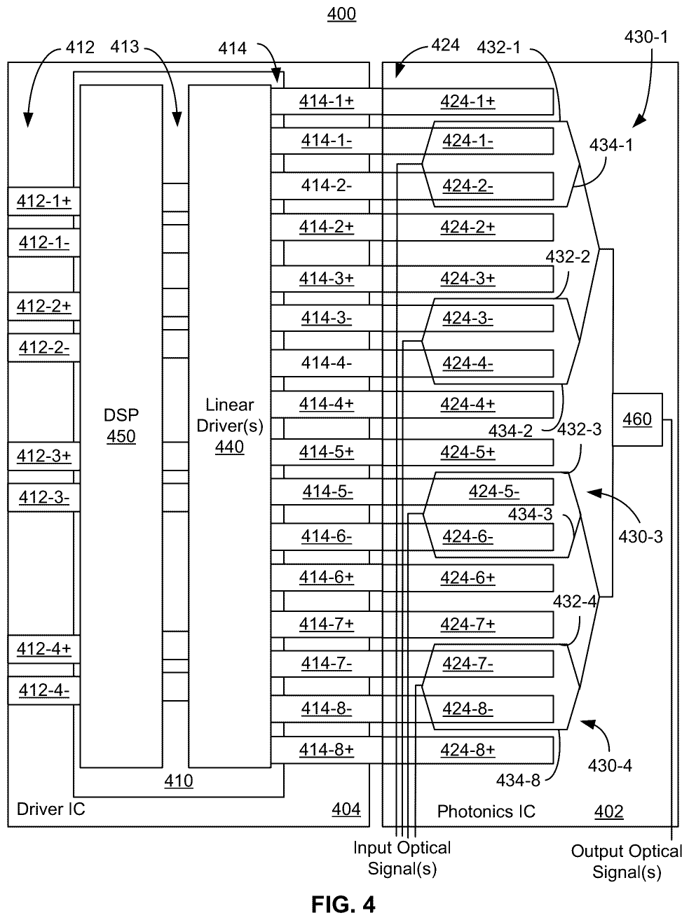

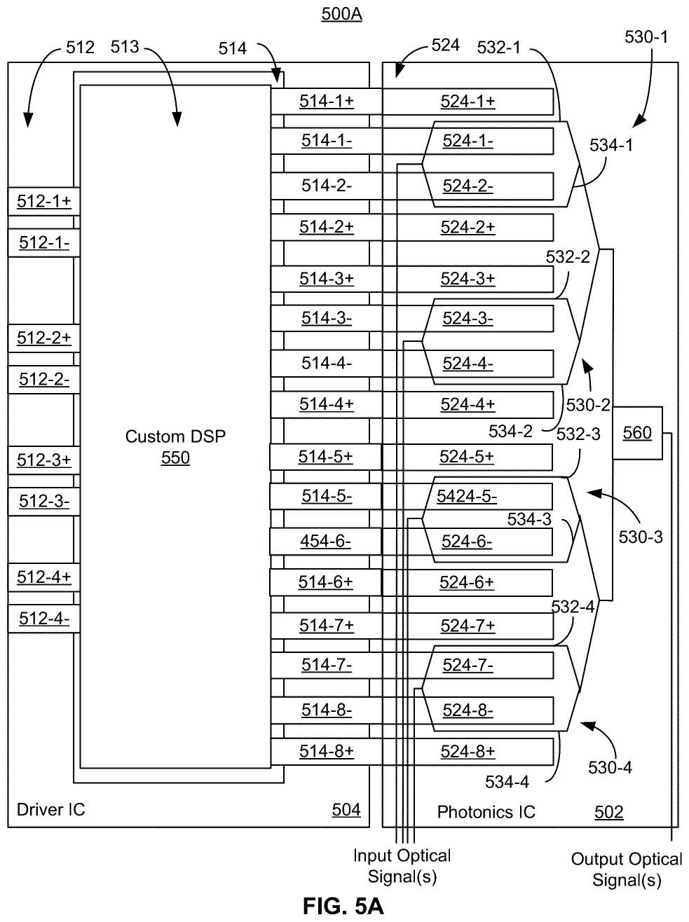

FIG. 4 depicts a plan view of an embodiment of electro-optic device 400. For clarity, not all components are shown and FIG. 4 is not to scale. Electro-optic device 400 includes driver integrated circuit 404, driver module 410, differential inputs 412, differential outputs 414, photonics integrated circuit 402, waveguides 430, and differential electrodes 424 that are analogous to driver integrated circuit 104, driver module 110, differential inputs 112, differential outputs 114, photonics integrated circuit 102, waveguides 130, and differential electrodes 124 of electro-optic device 100. In the embodiment shown in FIG. 4, the output optical signals from waveguides 430 are combined. In other embodiments, the output optical signals may not be combined or may be combined in a different manner. Further, as can be seen in FIG. 4, the number of differential outputs 414 and thus the number of differential electrodes 424 is an even integer multiplied by the number of differential inputs 412. More specifically, electro-optic device 400 includes four differential inputs 412, eight differential outputs 414, eight differential electrodes 424, and four waveguides 430. In some embodiments, another number of differential inputs 412, differential outputs 414, differential electrodes 424, and/or waveguides 430 may be used.

In driver integrated circuit 404, both a DSP 450 (e.g., a coherent DSP) and linear driver(s) 330 are included. DSP 450 is coupled with linear driver 430 via connectors 413. In some embodiments, electro-optic device 400 is configured as an IQ modulator (e.g. a DP IQ modulator). Thus, output optical signals from waveguides 430 are combined and provided to PRS (polarization rotation slitter) 460. DSP 450 may be a standard DSP, while linear drivers 440 may contain drivers (e.g. four drivers) analogous to linear driver 300. Thus, driver 440 may be a custom driver. Although shown as being implemented on a single integrated circuit 404, in some embodiments, DSP 450 and driver(s) 440 may be implemented on separate integrated circuits.

Electro-optic device 400 operates in an analogous manner to and may share the benefits of electro-optic devices 100 and/or 200. For example, electro-optic device 400 may be low jitter, have a high bandwidth, low loss, use a lower driving voltage for the desired Vπ, and a zero common mode. Moreover, binary weighted signals may be combined (e.g. two NRZ combined to form a PAM-4 signal). DSP 450 may be simplified and less power used in driving electro-optic device 400. Thus, performance may be improved. Further, traces that are shorter than the wavelength of the RF signal may be used in linear amplifier 300. Such short traces allow these components to act as nodes, rather than transmission lines. Consequently, losses may be reduced. Performance of electro-optic device 400 may, therefore, be improved.

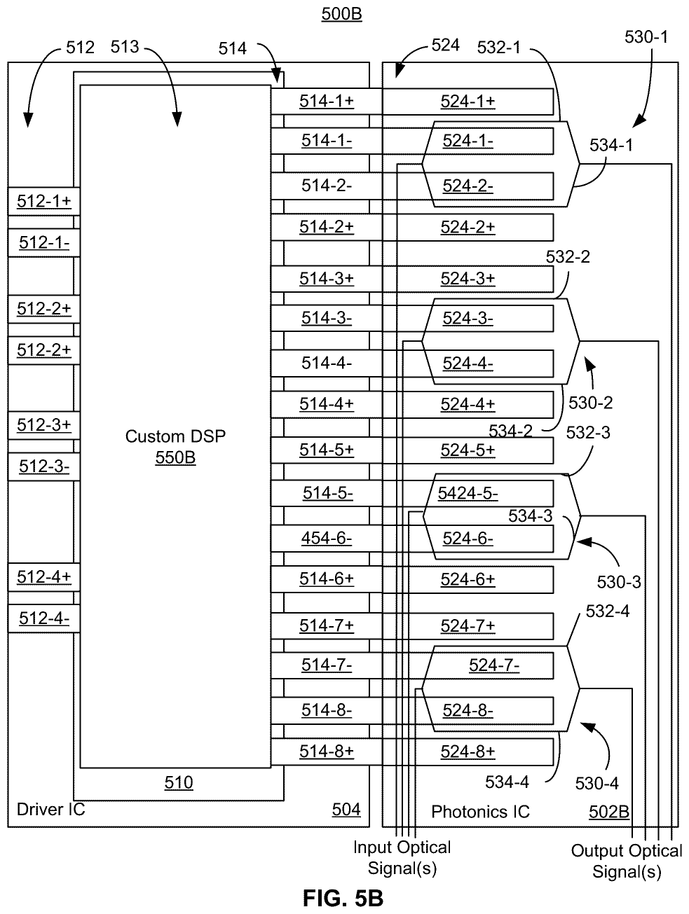

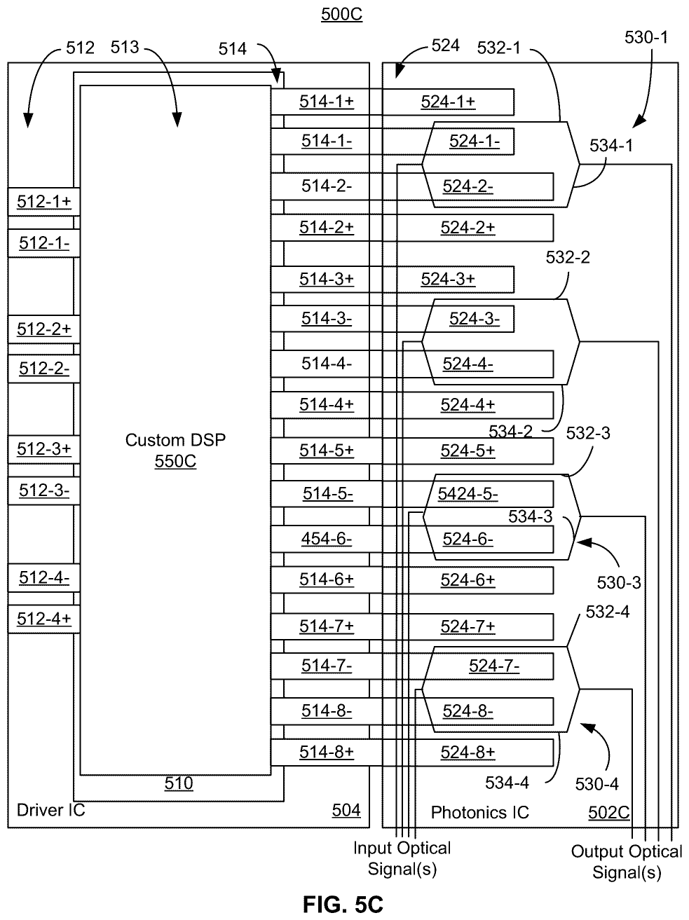

FIGS. 5A-5C depict plan views of embodiments of electro-optic devices 500A, 500B, and 500C. For clarity, not all components are shown and FIGS. 5A-5C are not to scale. Each electro-optic devices 500A, 500B, and 500C includes driver integrated circuit 504, driver module 510, differential inputs 512, differential outputs 514, photonics integrated circuit 502, 502B, and 502C, waveguides 530, and differential electrodes 524 that are analogous to driver integrated circuit 104, driver module 110, differential inputs 112, differential outputs 114, photonics integrated circuit 102, waveguides 130, and differential electrodes 124 of electro-optic device 100. Further, as can be seen in FIGS. 5A-5C, the number of differential outputs 514 and thus the number of differential electrodes 524 is an even integer multiplied by the number of differential inputs 512. More specifically, electro-optic device 500 includes four differential inputs 512, eight differential outputs 514, eight differential electrodes 524, and four waveguides 530. In some embodiments, another number of differential inputs 512, differential outputs 514, differential electrodes 524, and/or waveguides 530 may be used.

In driver integrated circuit 504, custom DSPs 550A, 550B, and 550C are used. In other embodiments, driver module 510 may be analogous to driver modules 110, 210, or 410 (e.g., including only linear amplifier(s) or include both a DSP and a linear amplifier). Custom DSPs 550A, 550B, and 550C may each be a coherent DSP. In some embodiments, electro-optic device 500A is configured as an IQ modulator (e.g. a DP IQ modulator). Thus, output optical signals from waveguides 530 are combined and provided to PRS (polarization rotation slitter) 560. In contrast, electro-optic device 500B is configured as a modulator (e.g., a Mach-Zehnder interferometer). Thus, the optical signals from arms 532 and 534 are combined for each waveguide 530 and provided as individual optical output signals. Electro-optic device 500C is also configured as a modulator. However, the modulation provided on waveguide arms 532 explicitly differs from the modulation provided on waveguide arms 534 for the same positive and negative differential signals. In particular, electrodes 524-i+ and 524-i− are proximate to arms 532-i for a different (i.e., smaller) length than for arms 534-i. This provides a mechanism for allowing for binary weighting of optical output signal through the use of photonics IC 502C instead of the differential electrode signals provided by DSP 550C.

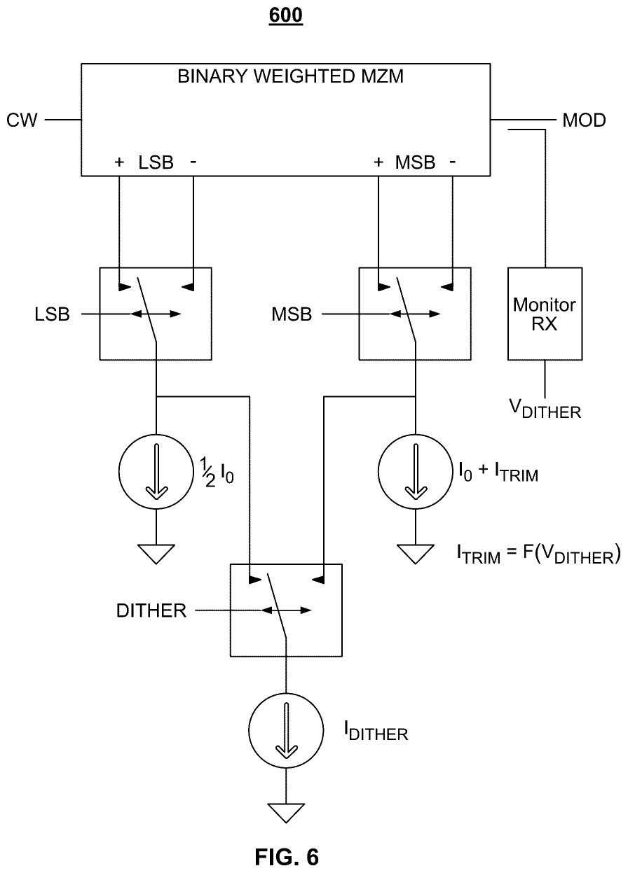

Further, DSPs 550A, 550B, and 550C may be configured to stabilize the electrode signals provided to photonics integrated circuits 502A, 502B, and 502C. FIG. 6 depicts an embodiment of a circuit 600 usable in controlling the levels of the differential electrode signals. In particular, using circuit 600 (or an analogous circuit), DSPs 550A, 550B, and 550C may provide a dither tone and use feedback from electrodes 524 for the dither tone to adjust the level of the differential signals provided to electrodes 524. Such an ability may be particularly useful for performing functions such as binary weighting (e.g., combining two PAM-4 or two PAM-8 signals on inputs 512).

Electro-optic devices 500A, 500B, and/or 500C operate in an analogous manner to and may share the benefits of electro-optic devices 100, 200, and/or 400. For example, electro-optic devices 500A, 500B, and/or 500C may be low jitter, have a high bandwidth, low loss, use a lower driving voltage for the desired Vπ, and a zero common mode. Moreover, binary weighted signals may be combined (e.g. two NRZ combined to form a PAM-4 signal). DSPs 550A, 550B, and/or 550C may be simplified and less power used in driving electro-optic devices 500A, 500B, and/or 500C. Thus, performance may be improved. Further, traces that are shorter than the wavelength of the RF signal may be used in linear amplifier 300. Such short traces allow these components to act as nodes, rather than transmission lines. Consequently, losses may be reduced. The levels for differential signals provided to differential electrodes 124 may also be better adjusted on chip using circuit 600. Performance of electro-optic devices 500A, 500B, and 500C may, therefore, be improved.

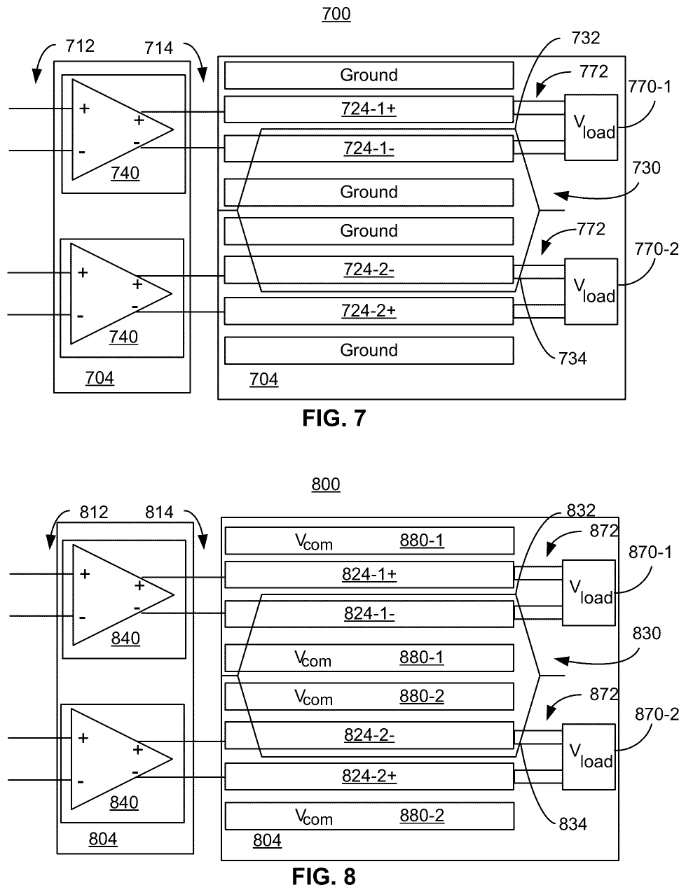

FIG. 7 depicts a plan view of an embodiment of electro-optic device 700. For clarity, not all components are shown and FIG. 7 is not to scale. Electro-optic device 700 includes drivers 740 that may be implemented on driver integrated circuit 704 (e.g. as part of a driving module), differential inputs 712, differential outputs 714, photonics integrated circuit 702, waveguide 730, and differential electrodes 724 that are analogous to drivers 300 and driver integrated circuit 104, differential inputs 112, differential outputs 114, photonics integrated circuit 102, waveguides 130, and differential electrodes 124 of electro-optic device 100. In some embodiments, another number of differential inputs 712, differential outputs 714, differential electrodes 724, and/or waveguides 730 may be used.

In driver integrated circuit 704, drivers 740 may be open collector drivers. Consequently, drivers 740 may output signals having a nonzero common mode voltage. In such cases, each of the differential signals on each output 714 oscillates around and is centered on the (nonzero) common mode. The differential voltage swing is the difference between the maximum and minimum voltage of an output signal around the common mode. For example, if the differential signals provided on outputs are Vout-a and Vout-b, the swing is maximum of Vout-a minus the minimum of Vout-b. The voltage supplied to driver 740, Vload, is greater than the common mode plus ½ of the swing to provide sufficient voltage for driver to operate as desired. In some embodiments, therefore, differential electrodes 724 are desired to be terminated. In such an embodiment, Vload 770 may be supplied through photonics integrated circuit 704. In electro-optic device 700, Vload 770 (e.g. 770-1 and 770-2) may be supplied through termination resistors 772 (of which only two are labeled). The termination is chosen to be impedance match to the differential lines 724 and drivers 740. For example if open collector driver 740 has 60 Ohm differential impedance, then each of the two resistors 772 has a 30 Ohm resistance.

Electro-optic device 700 operates in an analogous manner to and may share the benefits of electro-optic devices 100, 200, 400, 500A, 500B, and/or 500C. For example, electro-optic device 700 may be low jitter, have a high bandwidth, low loss, use a lower driving voltage for the desired Vπ, and a zero common mode. Moreover, binary weighted signals may be combined (e.g. two NRZ combined to form a PAM-4 signal). Thus, performance may be improved. Further, traces that are shorter than the wavelength of the RF signal may be used in drivers 740. Such short traces allow these components to act as nodes, rather than transmission lines. Consequently, losses may be reduced. The levels of differential signals provided to electrodes 724 may also be better adjusted. Electro-optic device 700 may also be used in conjunction with an open collector driver 740. Performance of electro-optic device 700 may, therefore, be improved.

FIG. 8 depicts a plan view of an embodiment of electro-optic device 800. For clarity, not all components are shown and FIG. 8 is not to scale. Electro-optic device 800 includes drivers 840 that may be implemented on driver integrated circuit 804 (e.g. as part of a driving module), differential inputs 812, differential outputs 814, photonics integrated circuit 802, waveguide 830, and differential electrodes 824 that are analogous to drivers 300 and driver integrated circuit 104, differential inputs 112, differential outputs 114, photonics integrated circuit 102, waveguides 130, and differential electrodes 124 of electro-optic device 100. In some embodiments, another number of differential inputs 812, differential outputs 814, differential electrodes 824, and/or waveguides 830 may be used.

In driver integrated circuit 804, drivers 840 may be open collector drivers analogous to drivers 740. In some embodiments, therefore, differential electrodes 824 are desired to be terminated. In such an embodiment, Vload 870 may be supplied through photonics integrated 804. In electro-optic device 800, Vload 870, which is analogous to Vload 770 and may be supplied through termination resistors 872 (of which only two are labeled) that are analogous to termination resistor 772. In addition, Vcom (common mode) biasing lines 880 are present. Biasing lines 880 provide the common voltage (Vcom) for drivers 840. This leads to no DC voltage being dropped across the gap between the inner signal lines and the outer electrodes

Electro-optic device 800 operates in an analogous manner to and may share the benefits of electro-optic devices 100, 200, 400, 500A, 500B, 500C, and/or 700. For example, electro-optic device 800 may be low jitter, have a high bandwidth, low loss, use a lower driving voltage for the desired Vπ, and a zero common mode. Moreover, binary weighted signals may be combined (e.g. two NRZ combined to form a PAM-4 signal). Thus, performance may be improved. Further, traces that are shorter than the wavelength of the RF signal may be used in drivers 840. Such short traces allow these components to act as nodes, rather than transmission lines. Consequently, losses may be reduced. The levels of differential signals provided to electrodes 824 may also be better adjusted. Electro-optic device 800 may also be used in conjunction with an open collector driver 840. Performance of electro-optic device 800 may, therefore, be improved.

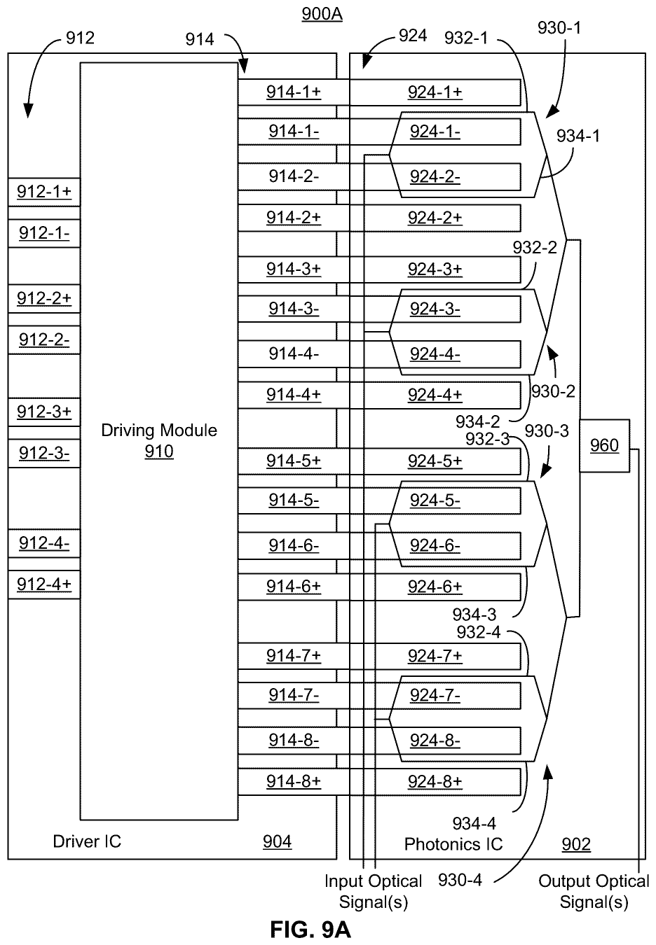

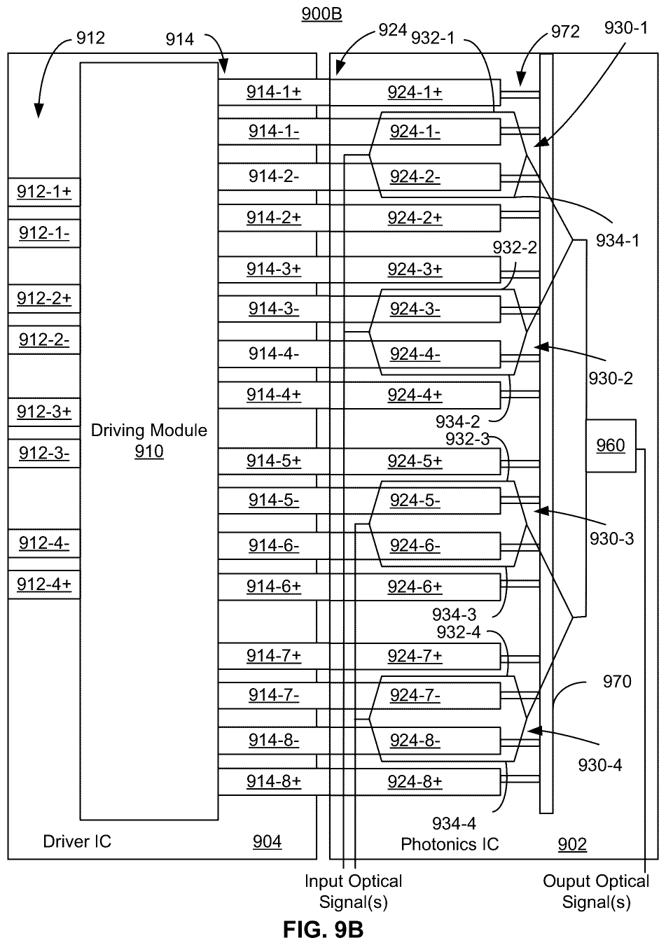

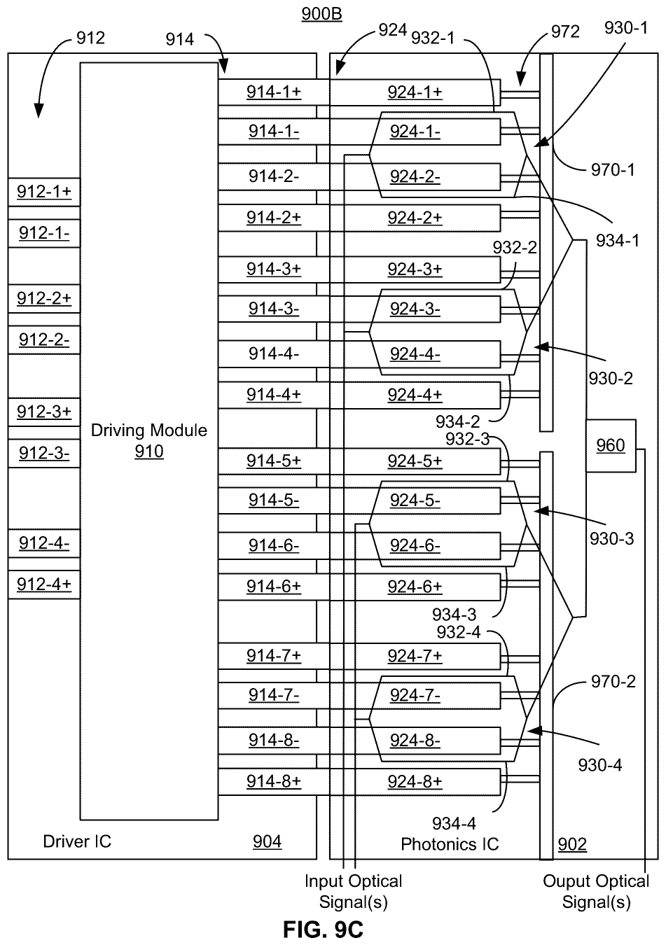

FIGS. 9A, 9B, and 9C depict plan views of embodiments of electro-optic devices 900A, 900B, and 900C. For clarity, not all components are shown and FIGS. 9A, 9B, and 9C are not to scale. Electro-optic devices 900A, 900B, and 900C each includes driving module 910 of driver integrated circuit 904, differential inputs 912, differential outputs 914, photonics integrated circuit 902, waveguide 930, and differential electrodes 924 that are analogous to driving module 110 of driver integrated circuit 104, differential inputs 112, differential outputs 114, photonics integrated circuit 102, waveguides 130, and differential electrodes 124 of electro-optic device 100. In some embodiments, another number of differential inputs 912, differential outputs 914, differential electrodes 924, and/or waveguides 930 may be used. In electro-optic devices 900B and 900C, driving module 910 may utilize open collector drivers, such as drivers 740 and 840.

Electro-optic devices 900A, 900B, and 900C may be DPIQ modulators. However, portions of other types of modulators may be configured in an analogous manner to that shown in FIGS. 9A-9C. Each electro-optic device 900A, 900B, and 900C eight differential electrodes 924. Electro-optic device 900A may be analogous to electro-optic device 500A. However, electro-optic devices 900B and/or 900C may utilize open collector drivers in driving module 900. Thus, electro-optic device 900B includes termination resistors 972 (of which only one is labeled) and load voltage module Vload 970 that is common across all differential electrodes 924. Thus, electro-optic device 900B is analogous to electro-optic device 700. Similarly, electro-optic device 900C includes termination resistors 972 (of which only one is labeled) and Vload 970-1 and 970-2 that is common across portions of differential electrodes 924. In some embodiments, the load voltage Vload may be provided in another manner.

Electro-optic devices 900A, 900B, and 900C operate in an analogous manner to and may share the benefits of electro-optic devices 100, 200, 400, 500A, 500B, 500C, and/or 700. For example, each electro-optic device 900A, 900B, and/or 900C may be low jitter, have a high bandwidth, low loss, use a lower driving voltage for the desired Vπ, and a zero common mode. Moreover, binary weighted signals may be combined (e.g. two NRZ combined to form a PAM-4 signal). Thus, performance may be improved. Further, traces that are shorter than the wavelength of the RF signal may be used in drivers of driving module 910. Such short traces allow these components to act as nodes, rather than transmission lines. Consequently, losses may be reduced. The levels of differential signals provided to electrodes 924 may also be better adjusted. Electro-optic devices 900A, 900B, and 900C may also be used in conjunction with open collector drivers. Performance of electro-optic devices 900A, 900B, and 900C may, therefore, be improved.

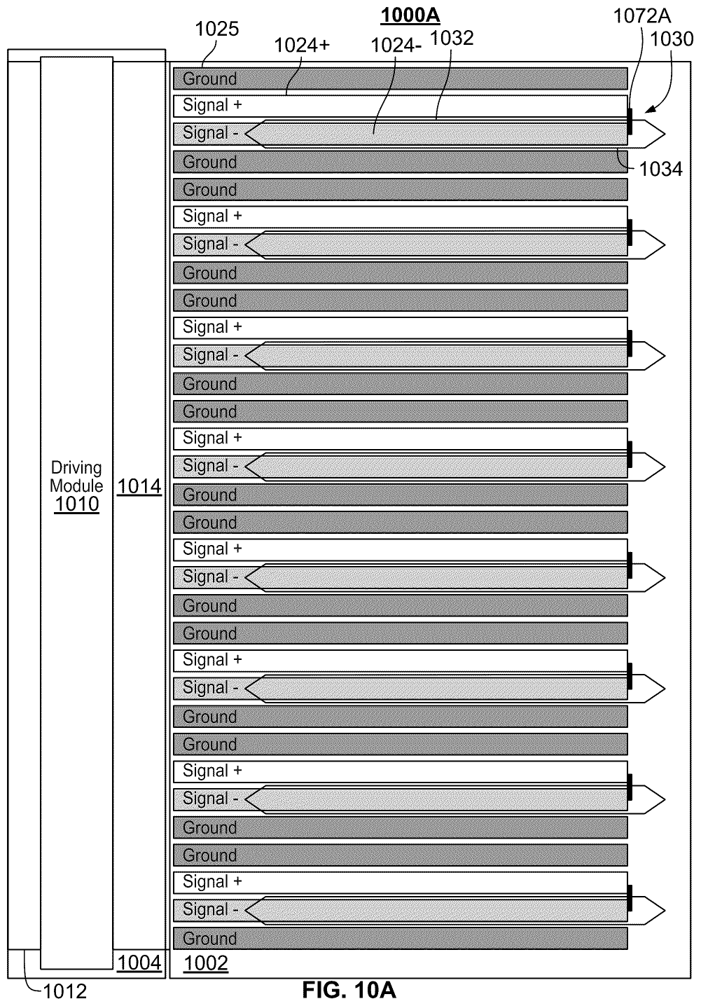

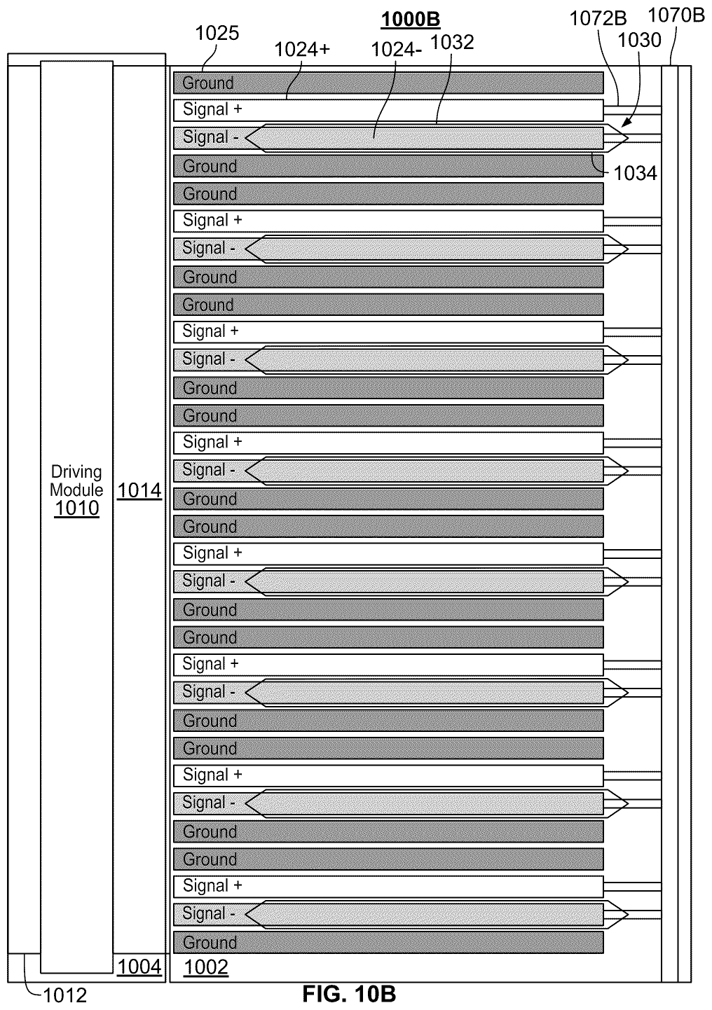

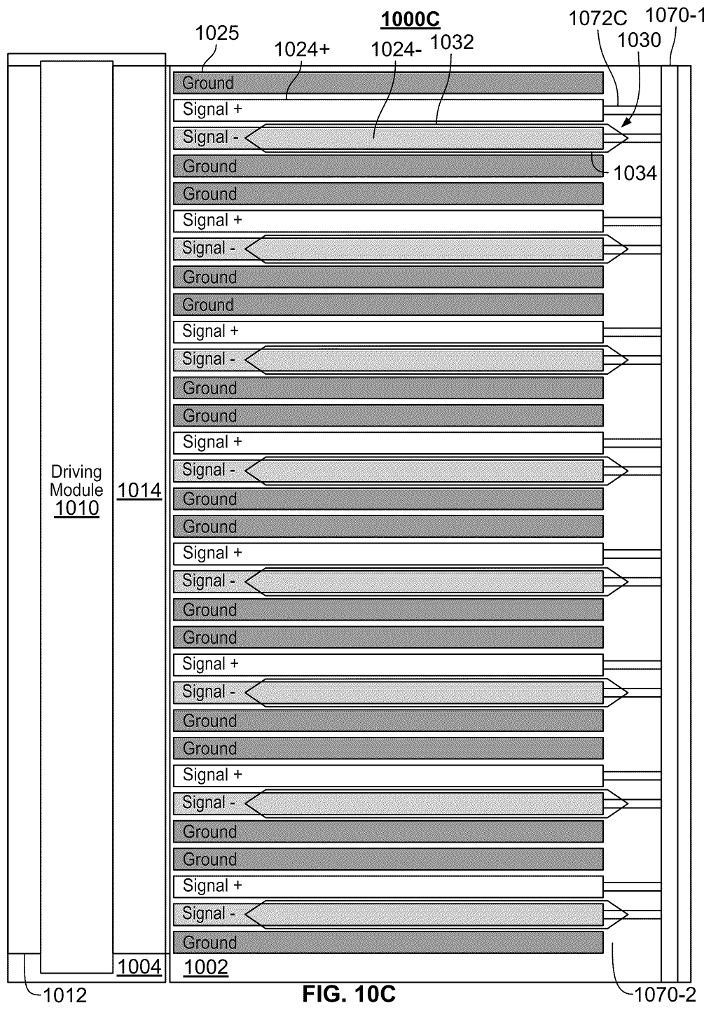

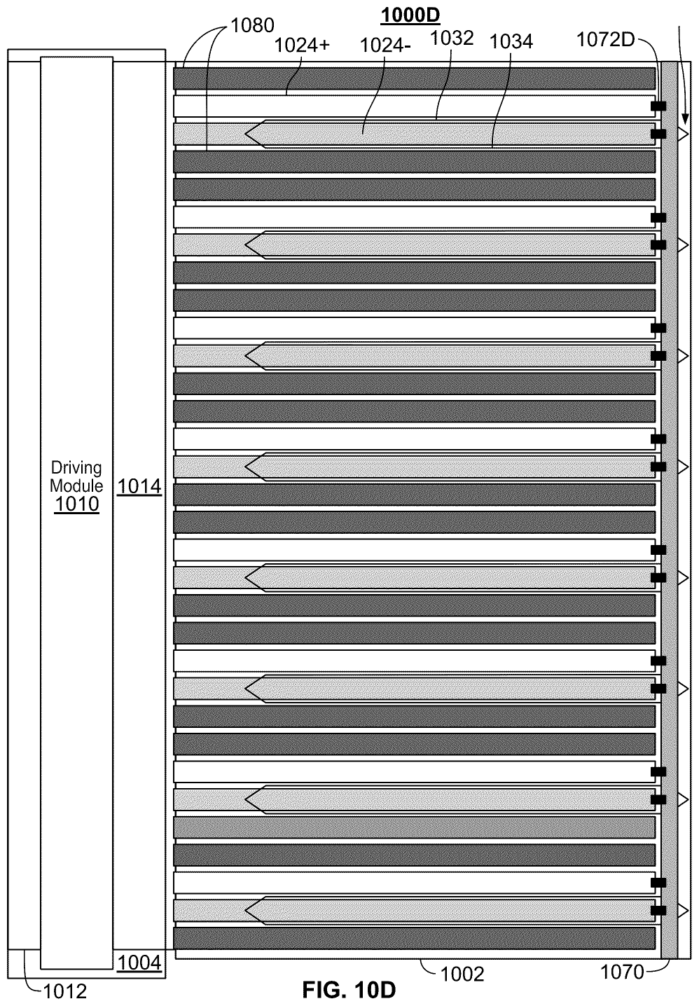

FIGS. 10A, 10B, 10C, and 10D depict plan views of embodiments of electro-optic devices 1000A, 1000B, 1000C, and 1000D. For clarity, not all components are shown and FIGS. 10A, 10B, 10C, and 10D are not to scale. Electro-optic devices 1000A, 1000B, 1000C, and 1000D each includes driving module 1010 of driver integrated circuit 1004, differential inputs 1012 (merely indicated by block 1012), differential outputs 1014 (indicated by block 1014), photonics integrated circuit 1002, waveguide 1030, and differential electrodes 1024 that are analogous to driving module 110 of driver integrated circuit 104, differential inputs 112, differential outputs 114, photonics integrated circuit 102, waveguides 130, and differential electrodes 124 of electro-optic device 100. In some embodiments, another number of differential inputs 1012, differential outputs 1014, differential electrodes 1024, and/or waveguides 1030 may be used. In electro-optic devices 1000A, 1000B, 1000C, and 1000D, driving module 1010 may utilize open collector drivers, such as drivers 740 and 840. Further, only one differential electrode (1024+/1024− labeled) is labeled. Differential electrodes 1024 include one electrode between arms 1032 and 1034 of each waveguide and one electrode 1024+ on the opposite side of arms 1032. Further, additional grounds 1025 (of which, only one is labeled) are present in electro-optic devices 1000A, 1000B, and 1000C. electro-optic device 1000D includes common lines 1080 analogous to common lines 880.

Electro-optic devices 1000A, 1000B, 1000C, and 1000D may be intensity modulation direct detection (IMDD) modulators including eight waveguides 1030. However, portions of other types of modulators may be configured in an analogous manner to that shown in FIGS. 10A-10D. Electro-optic device 1000A includes termination resistors 1072A (of which only one is labeled). In some embodiments, termination resistors 1072A might be omitted. Electro-optic device 1000B includes termination resistors 1072B (of which only one is labeled) and load voltage module Vload 1070 that is common across all differential electrodes 1024. Thus, electro-optic device 1000B is analogous to electro-optic device 700. Similarly, electro-optic device 1000C includes termination resistors 1072C (of which only one is labeled) and Vload 1070-1 and 1070-2 that is common across portions of differential electrodes 1024. In some embodiments, the load voltage Vload may be provided in another manner. Electro-optic device 1000D includes common voltage lines 1080 as well as termination resistors 1072D and Vload 1070.

Electro-optic devices 1000A, 1000B, 1000C, and 1000D operate in an analogous manner to and may share the benefits of electro-optic devices 100, 200, 400, 500A, 500B, 500C, 700, 800, 900, 900B, and/or 900C. For example, each electro-optic device 1000A, 1000B, 1000C, and/or 1000D may be low jitter, have a high bandwidth, low loss, use a lower driving voltage for the desired Vπ, and a zero common mode. Moreover, binary weighted signals may be combined (e.g. two NRZ combined to form a PAM-4 signal). Thus, performance may be improved. Further, traces that are shorter than the wavelength of the RF signal may be used in drivers of driving module 1010. Such short traces allow these components to act as nodes, rather than transmission lines. Consequently, losses may be reduced. The levels of differential signals provided to electrodes 1024 may also be better adjusted. Electro-optic devices 1000A, 1000B, 1000C, and 1000D may also be used in conjunction with open collector drivers. Performance of electro-optic devices 1000A, 1000B, 1000C, and 1000D may, therefore, be improved.

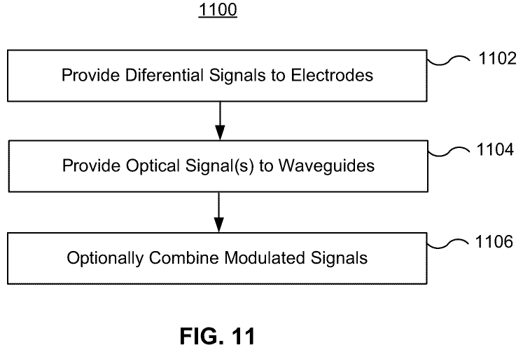

FIG. 11 is a flow-chart depicting an embodiment of method 1100 for modulating an optical signal. Thus, method 1100 may be used to modulate an optical signal. Method 1100 is described in the context of processes that may have sub-processes. Although described in a particular order, another order not inconsistent with the description herein may be utilized. Further, although described in the context of a single optical input and a particular number of differential signals, method 1100 may be extended to multiple optical signals and multiple differential signals.

A driving module having a first number of differential inputs and a second number of differential outputs provides differential signals to a plurality of differential electrodes, at 1102. As part of 1102, the differential signal provided to the inputs of the driving module is split and, in some embodiments, amplified. Other processing may be performed.

At 1104, an optical signal is provided to each of a plurality of waveguides. In some embodiments, multiple optical signals are input to the device. In some embodiments, one or more optical signals are split to be provided to different waveguides. The waveguides include TFLC electro-optic material(s), such as TFLN and/or TFLT. Each of the waveguides has multiple arms. Thus, 1104 may include further splitting the input optical signal(s). Each of the differential electrodes includes a positive electrode and a negative electrode that are in proximity to the arm(s) of the waveguides. Because of 1102, 1104, and the configuration of the electro-optic device the optical signals are modulated in this region of the electro-optic device. Further, the modulated signals from each arm of a waveguide may be recombined as part of 1104. A modulated, combined optical signal may thus be produced.

The method may, optionally, include further combining the (combined) modulated optical signals from multiple waveguides, at 1106. As part of 1106. In some embodiments, however, the combined modulated signal from each waveguide is output or otherwise processed.

For example, method 1100 may be used in conjunction with optical device 100. At 1102, driver module 110 provides differential electrode signals to electrodes 124. Optical signals are provided to waveguides 130, at 1104. The optical signal to each waveguide 130 is split to arms 132 and 134. Further, the differential electrode signals provided to electrodes 124 modulate the optical signal in each arm 132 and 134. In electro-optic device 100, the outputs of waveguides 130 are not combined. Thus, 1106 is omitted for electro-optic device 100. However, for electro-optic device 200, the outputs of waveguides 230 are combined and output. As part of combining the modulated, combined optical signals, other processing may occur. For example PRS 460 might be used as part of 1106 for electro-optic device 400.

Using method 1100 an optical signal may be modulated using a larger number of differential electrodes, a low power driver, with low optical losses, high bandwidth, an enhanced vπ, and/or the ability to perform other functions such as binary weighting. Thus, performance of the optical devices may be improved.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. An optical modulator, comprising:
a driving module having a first number of differential inputs and a second number of differential outputs, the second number being equal to the first number multiplied by an even integer;
at least one waveguide including a thin film lithium-containing (TFLC) electro-optic material, each of the at least one waveguide having a plurality of arms;
a plurality of differential electrodes coupled to the second number of differential outputs, each of the plurality of differential electrodes including a positive electrode and a negative electrode, at least a portion of an arm of the plurality of arms between a portion of the positive electrode and a portion of the negative electrode.

2. The optical modulator of claim 1, further comprising:
a digital signal processor (DSP) having at least one input and a plurality of differential outputs, the plurality of differential outputs of the DSP being coupled with the first number of differential inputs for the driving module; and
wherein the driving module includes a linear driver coupled with the DSP and configured to convert the first number of differential inputs to the second number of differential outputs.

3. The optical modulator of claim 2, wherein the DSP further provides a dither tone, the plurality of differential electrodes providing feedback to the DSP based on the dither tone, the DSP configured to trim signals provided on the plurality of differential outputs based on the feedback.

4. The optical modulator of claim 1, wherein the driving module includes:
a digital signal processor (DSP) having at least one input and a plurality of differential outputs, the plurality of differential outputs of the DSP being coupled with the first number of differential inputs for the driving module; and
a driver coupled with the DSP and configured to convert the first number of differential inputs to the second number of differential outputs.

5. The optical modulator of claim 1, wherein the driving module provides a plurality of differential signals on the plurality of differential outputs, the plurality of differential signals having a zero DC component.

6. The optical modulator of claim 1, wherein a first signal is provided to the positive electrode and a second signal is provided to the negative electrode of a differential electrode of the plurality of differential electrodes, the first signal being different from the second signal.

7. The optical modulator of claim 6, wherein the first signal and the second signal each includes at least one of a binary signal, a PAM-4 signal, a PAM 8 signal, a PAM-16 signal, a PAM-32 signal, and a PAM 64 signal.

8. The optical modulator of claim 1, wherein the portion of the positive electrode is proximate to the arm along a first distance and the portion of the negative electrode is proximate to the arm for a second distance for an of the plurality of arms, the first distance being different from the second distance.

9. The optical modulator of claim 1, wherein the driving module includes an open collector driver and wherein the positive electrode and the negative electrode of each of the plurality of differential electrodes are terminated through at least one resistor to a voltage load.

10. The optical modulator of claim 9, further comprising:
a plurality of ground lines interleaved with the plurality of differential electrodes, the plurality of ground lines being biased at a common voltage.

11. The optical modulator of claim 1, wherein the at least one waveguide, the driving module, and the plurality of differential outputs are configured to function as an intensity modulator, an intensity modulation direct detection (IMDD) modulator, and an in-phase quadrature (IQ) modulator.

12. The optical modulator of claim 1, wherein the optical modulator has a bandwidth including a frequency of one hundred GHz and not more than three hundred GHz.

13. The optical modulator of claim 12 wherein the bandwidth has a minimum frequency of not less than 50 GHz.

14. An optical modulator, comprising:
a driving module including a digital signal processor (DSP) and a linear driver coupled with the DSP, the DSP having at least one input and a plurality of differential outputs, the linear driver having a first number of differential inputs and having a second number of differential outputs, the plurality of differential outputs of the DSP being coupled with the first number of differential inputs for the linear driver, the linear driver being configured to convert the first number of differential inputs to a second number of differential outputs, the second number being the first number multiplied by an even integer, the linear driver having a loss of not more than 3 dB;
a plurality of waveguides including a thin film lithium-containing (TFLC) electro-optic material, each of the plurality of waveguides having a plurality of arms;
a plurality of differential electrodes coupled to the second number of differential outputs, each of the plurality of differential electrodes including a positive electrode and a negative electrode, at least a portion of an arm of the plurality of arms between a portion of the positive electrode and a portion of the negative electrode;
wherein the optical modulator has a bandwidth including a frequency of one hundred GHz, the bandwidth not exceeding a maximum frequency of three hundred GHz.

15. The optical modulator of claim 14, wherein the driving module provides a plurality of differential signals on the plurality of differential outputs, the plurality of differential signals having a zero DC component.

16. The optical modulator of claim 14, wherein a first signal is provided to the positive electrode and a second signal is provided to the negative electrode of a differential electrode of the plurality of differential electrodes, the first signal being different from the second signal.

17. A method, comprising:
providing, from a driving module having a first number of differential inputs and a second number of differential outputs and to a plurality of differential electrodes, a plurality of differential signals, the second number being equal to the first number multiplied by an even integer;
providing, to each of a plurality of waveguides including a thin film lithium-containing (TFLC) electro-optic material, an optical signal, each of the plurality of waveguides having a plurality of arms, each of the plurality of differential electrodes including a positive electrode and a negative electrode, at least a portion of an arm of the plurality of arms between a portion of the positive electrode and a portion of the negative electrode, such that the plurality of differential signal modulate the optical signal in each of the plurality of waveguides; and
combining the modulated optical signal from each of the plurality of waveguides.

18. The method of claim 17, wherein the plurality of waveguides, the driving module, and the plurality of differential outputs are configured to function as an intensity modulator, an intensity modulation direct detection (IMDD) modulator, and an in-phase quadrature (IQ) modulator.

19. The method of claim 17, wherein the providing the plurality of differential signals further includes:
providing a first signal to the positive electrode and a second signal to the negative electrode of a differential electrode of the plurality of differential electrodes, the first signal being different from the second signal.

20. The method of claim 19. wherein the first signal and the second signal each includes at least one of a binary signal, a PAM-4 signal, a PAM 8 signal, a PAM-16 signal, a PAM-32 signal, and a PAM 64 signal.
